(19) United States
(12) Patent Application Publication
(10) Pub. No.: US 2006/0289036 A1
(43) Pub. Date: Dec. 28, 2006

(54) Gutter cleaning device

(76) Inventor: Richard J. Hilton, Winnipeg (CA)

Correspondence Address: ADE & COMPANY INC., P.O. BOX 28006 1795 HENDERSON HIGHWAY, WINNIPEG, MB, R2G1P0, CA

(21) Appl. No.: 11/449,691

(22) Filed: Jun. 9, 2006

Related U.S. Application Data
(60) Provisional application No. 60/693,068, filed on Jun. 23, 2005.

(51) Int. Cl. B08B 5/00

(52) U.S. Cl. 134/22.11; 15/405; 15/406; 134/22.12; 134/34

(57) ABSTRACT

A gutter cleaning device includes an elongate pole including a conduit extending therethrough for communication between a nozzle at a top end of the pole and a source of high pressure compressed gas at a bottom end of the pole. A trigger valve mechanism at the source controls dispensing of the gas through the nozzle. Use of a portable, replaceable canister of high pressure compressed air results in a light weight device which does not require any additional cords or hoses to be carried about the perimeter of a building having gutters to be cleared.

This application claims the benefit under 35 U.S.C. 119(e) of U.S. provisional application Ser. No. 60/693,068, filed Jun. 23, 2005.

### FIELD OF THE INVENTION

The present invention relates to a device and method for cleaning a gutter using compressed air releasable as a high pressure jet of air.

### BACKGROUND

A common problem with houses, having gutters along the edges of the roof for collecting rain water, is that the gutters tend to become plugged with various materials including silt washed off the shingles of the roof or leaves from nearby trees. Some attempts have been made to provide mechanical systems which assist in cleaning the gutters while the operator remains standing on the ground to reduce risk of injury from falling off the roof. In order to mechanically remove the leaves however, a complex mechanism is required as described in U.S. Pat. Nos. 3,751,749 and 6,185,782 for example.

Some attempts to clear debris from gutters include the use of a nozzle for directing a jet of water into the gutter. Various examples include U.S. Pat. No. 3,041,655 to Entler, U.S. Pat. No. 5,727,580 to Patterson, U.S. Pat. No. 5,898,969 to Middleton, U.S. Pat. No. 5,022,586 to Putnam, U.S. Pat. No. 2,710,616 to Tydings and U.S. Pat. No. 4,363,335 to Tapper. In general all of these systems require connection to a source of water, for example a garden hose, which may be cumbersome to carry about the perimeter of a house when cleaning the gutters. The resultant slurry of water and debris washed from the gutters is typically messy and requires considerable cleanup after the gutters have been cleared. The effectiveness of the cleaning is dependent upon a supply of adequate water pressure.

Other attempts to clear debris include use of a blower or a vacuum to move debris using a flow of air. U.S. Pat. No. 4,121,320 to Feiner, U.S. Pat. No. 5,056,187 to Higgins, U.S. Pat. No. 2,586,145 to Breuer et al. and U.S. Pat. No. 6,519,809 to Gutry disclose various examples of the use of either a blower or a vacuum in which a rotating impeller causes an air flow to produce the desired blowing or suction force. The rotating impeller results in a flow of air having limited pressure which accordingly has limited force to expel matter from a gutter. In addition the rotating impeller requires a heavy motor to be carried along with either a cumbersome electrical cord to be carried about the perimeter of the house or a gas tank which adds to the overall weight of the device.

### SUMMARY OF THE INVENTION

According to one aspect of the invention there is provided a gutter cleaning device using a compressed gas, the device comprising:

an elongate pole extending in a longitudinal direction between a top end and a bottom end;

a nozzle adjacent the top end of the pole which is directed transversely to the longitudinal direction of the pole;

a high pressure connection adjacent the bottom end of the pole which is arranged to connect to a supply of high pressure compressed gas;

a conduit extending in communication between the nozzle adjacent the top end of the pole and the high pressure connection adjacent the bottom end of the pole; and

a trigger valve mechanism connected in series with the conduit and being movable between a closed position restricting release of compressed gas through the conduit from the high pressure connection to the nozzle and an open position in which the high pressure connection openly communicates through the conduit with the nozzle.

According to a further aspect of the present invention there is provided a method of cleaning a gutter, the method comprising:

providing cleaning tool comprising: an elongate pole extending between a top end and a bottom end; a nozzle adjacent the top end of the pole which is directed at least partially downward toward the bottom end of the pole; and a conduit extending in communication between the nozzle and the bottom end of the pole;

connecting a supply of compressed gas to the conduit adjacent the bottom end of the pole;

restricting release of compressed gas through the conduit from the supply to the nozzle by providing a trigger valve mechanism connected in series with the conduit; and

periodically releasing the trigger valve mechanism so as to release compressed gas through the conduit, from the supply to the nozzle.

The method may include releasing the trigger valve mechanism in short sequential bursts.

The use of a source of high pressure compressed air, possibly in the range of up to 2000 psi, results in a much greater force being released from a smaller nozzle to adequately expel debris from a gutter with minimal effort. The resulting device is light weight and is releasable in quick bursts of high pressure air flow due to the high pressure trigger valve mechanism, so that material in the gutters can be somewhat agitated by the bursts of air to assist expelling the material from the gutter. Use of a portable, replaceable canister of high pressure compressed air results in a light weight device which does not require any additional cords or hoses to be carried about the perimeter of a building having gutters to be cleared.

The device may be provided in combination with a compressed air tank in which the high pressure connection is connected to the compressed air tank. Preferably, the high pressure connection is suitable for connection to pressures up to 2000 psi.

In a preferred embodiment, the pole comprises a plurality of modular sections connected in series with one another in the longitudinal direction with the conduit extending concentrically through the pole. Preferably a resilient sealing member forms a sealed connection between each adjacent pair of modular sections.

There may be provided a flexible hose coupling a portable high pressure compressed gas storage tank in communication with the high pressure connection. In this instance the tank preferably includes a mounting clip arranged to support the tank on a belt of a user.

When a portable high pressure compressed gas storage tank is coupled to the high pressure connection, there may be an inlet connector connected to the high pressure connection between the tank and the trigger valve mechanism which is arranged to connect to a compressor for refilling the tank. Preferably the inlet connector comprising a one way check valve arranged to only permit high pressure gas to flow into the device.

When there is provided an actuation lever biased from an actuated position to an unactuated position and being arranged to displace the trigger valve mechanism into the open when displaced into the actuated position, preferably a metering mechanism is arranged to return the trigger valve mechanism to the closed position after a metered amount of gas has been dispensed through the trigger valve mechanism in the open position even if the actuation lever remains in the actuated position.

Preferably the trigger valve mechanism is located adjacent the bottom end of the pole, spaced from the nozzle by a length of the pole.

The nozzle may include a main passage therethrough having a diameter of less than ¼ inch for releasing the compressed air as a high pressure jet of air therethrough.

In at least one embodiment, the conduit extends concentrically through the pole, wherein the pole comprises a rigid member having a generally U-shaped curve formed adjacent the top end thereof for directing the nozzle at least partially downward toward the bottom end of the pole.

There may be provided a portable tank storing compressed air therein which is directly and rigidly coupled to the pole by the high pressure connection.

Alternatively, the conduit may comprise a separate hose extending alongside the pole. When the pole is telescopic, the hose may be flexible to accommodate the variation in length of the pole.

In some embodiments, orientation of the nozzle may be adjustable in relation to the pole.

In one instance, the nozzle includes a plurality of nozzle tips each having a passage therethrough, in which the passages are oriented in different directions.

Alternatively, the nozzle comprises a centrally orientated mouth opening and a plurality of side passages smaller in diameter than the mouth opening in communication with the mouth opening at circumferentially spaced positions thereabout.

In another variant, the nozzle comprises a straight passage in series with a mouth of enlarged diameter projecting beyond the straight passage.

In this instance, the mouth may increase in diameter in the flow direction in a stepped manner or in a smooth and continuous manner.

Some embodiments of the invention will now be described in conjunction with the accompanying drawings in which:

### BRIEF DESCRIPTION OF THE DRAWINGS

FIG. 1 is a perspective view of a first embodiment of the gutter cleaning device.

FIG. 2 is a perspective view of the trigger valve mechanism connected to a high pressure tank containing compressed air therein.

FIG. 3 is a side elevational view of a further embodiment of the gutter cleaning device.

FIG. 4 is a perspective view of a top end of the gutter cleaning device according to FIG. 3.

FIG. 5 is a schematic view of an alternative nozzle for use with the gutter cleaning device described herein.

FIG. 6 and FIG. 7 are perspective and sectional side elevational views respectively of another embodiment of the nozzle.

FIG. 8 and FIG. 9 are perspective and sectional side elevational views respectively of yet another embodiment of the nozzle.

FIG. 10 and FIG. 11 are perspective and sectional side elevational views respectively of a further embodiment of the nozzle.

FIG. 12 is a perspective view of a further embodiment of the gutter cleaning device.

In the drawings like characters of reference indicate corresponding parts in the different figures.

### DETAILED DESCRIPTION

Referring to the accompanying figures there is illustrated a gutter cleaning device generally indicated by reference numeral 10. The device 10 uses compressed air from a source storing pressure between 20 and 2000 psi. Though various embodiments of the device 10 are described and illustrated herein, the common elements will first be described.

The device 10 includes an elongate rigid pole 12 supporting a nozzle member 14 at a top end 16. The pole extends longitudinally from the top end 16 to a bottom end 18. The nozzle member 14 includes a narrow main passage 20 therethrough having a diameter which is less than ¼ inch so that the compressed air is forced into a high pressured jet through the nozzle. The nozzle is supported at the top end 16 of the pole 12 in such a manner so as to be directed transversely to a longitudinal direction of the pole, at least partially downwardly back towards the bottom end 18 so that the nozzle can be directed downwardly into a gutter through the open top side thereof when the pole is supported by an operator on the ground in an upright orientation from the ground to the gutter.

A high pressure connection 22 is supported adjacent the bottom end 18 of the pole 12 opposite the nozzle. The high pressure connection comprises a threaded connector with suitable sealing rings for connection in an air tight manner to a supply of compressed air. The air supply comprises a compressed air tank 24 which is suitably sized for portability along with the pole 12 as it is carried about the perimeter of the building whose gutters are being cleaned.

A conduit 26 communicates in the longitudinal direction of the pole 12 between the nozzle member 14 and the high pressure connection 22. A high pressure trigger valve mechanism 28 is coupled in series with the conduit 26 adjacent the bottom end 18 of the pole so that release of compressed gas through the conduit from the high pressure connection to the nozzle is restricted when the trigger valve mechanism is in a closed position. Depressing the trigger valve mechanism causes it to be displaced into an open position in which the high pressure connection openly communicates through the conduit with the nozzle member.

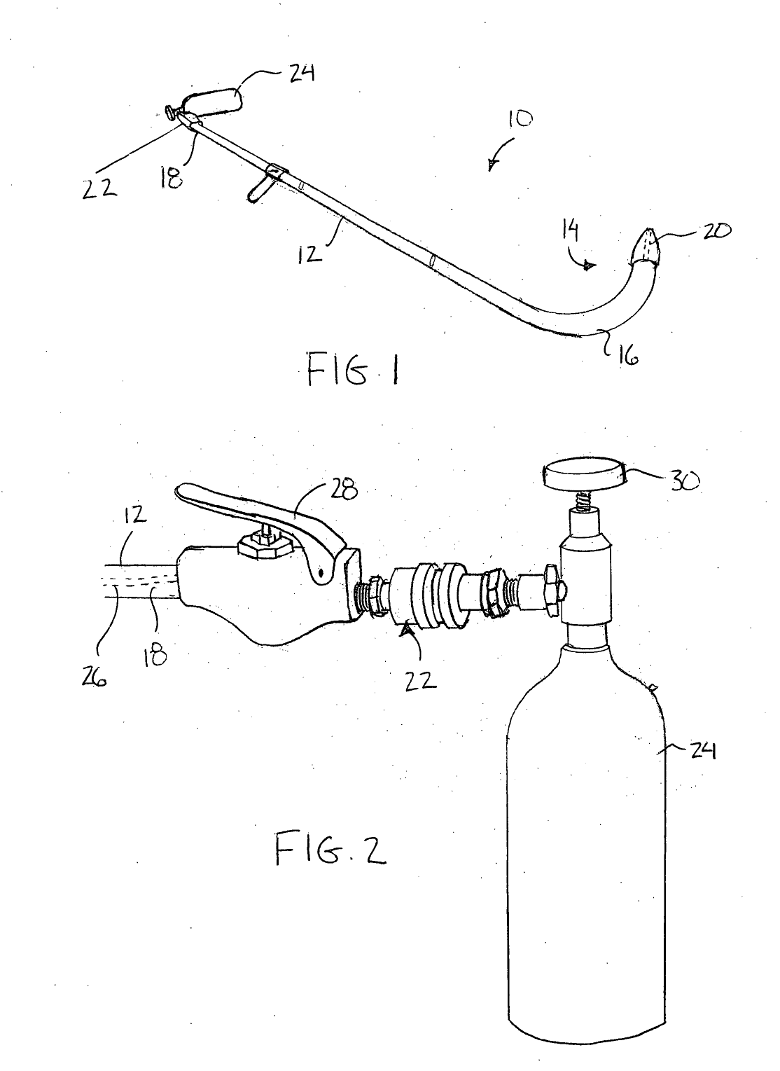

Turning now to the first embodiment of FIGS. 1 and 2, the pole 12 comprises a rigid pole having a fixed U-shaped curve formed adjacent the top end 16 thereof for supporting the nozzle member thereon to be directed partially downward back towards the bottom end 18. The conduit 26 extends concentrically through the pole from the high pressure connection to the nozzle member. The air tank 24 in this instance comprises a small light weight portable tank which is releasably connected to the high pressure connection. The tank 24 may thus comprise a replaceable cartridge which is threadably attached and released as desired by providing a valve on the tank itself which closes when the tank is separated from the connection 22. The connection 22 thus includes a suitable pin for engaging the tank and opening the tank valve as in conventional replaceable high pressure tanks.

A shutoff valve 30 is provided on the high pressure connection 22 in the form of a threaded tap which contains the high pressure within the tank when closed.

The trigger valve mechanism 28 is similar to conventional triggers for air tools and is mounted on the bottom end 18 of the pole. The pole is continuous as a solid piece or in segmented pieces having fixed connectors so that the assembled structure has no moving parts.

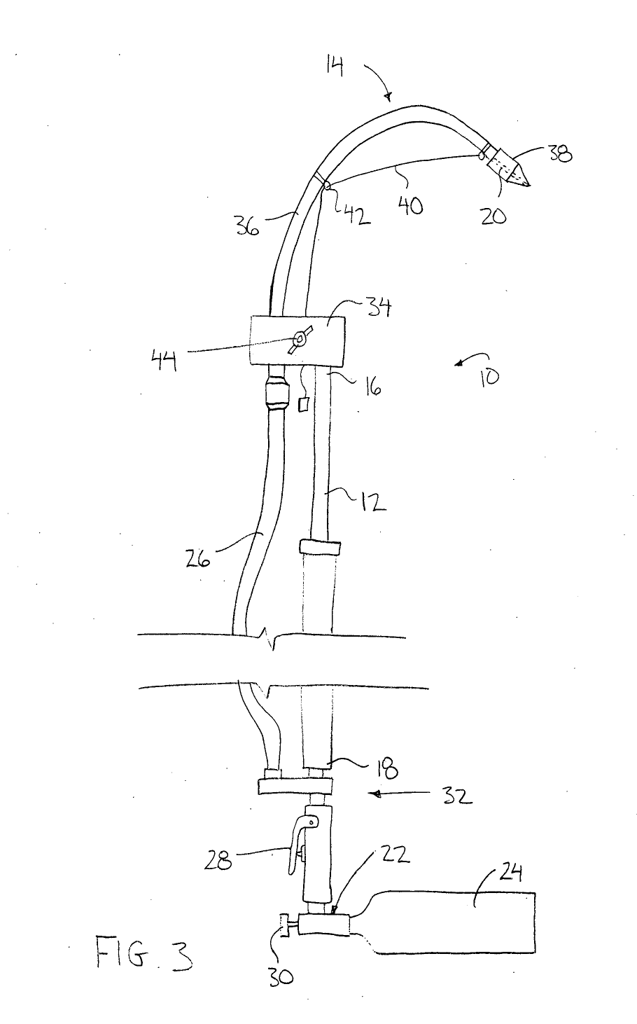

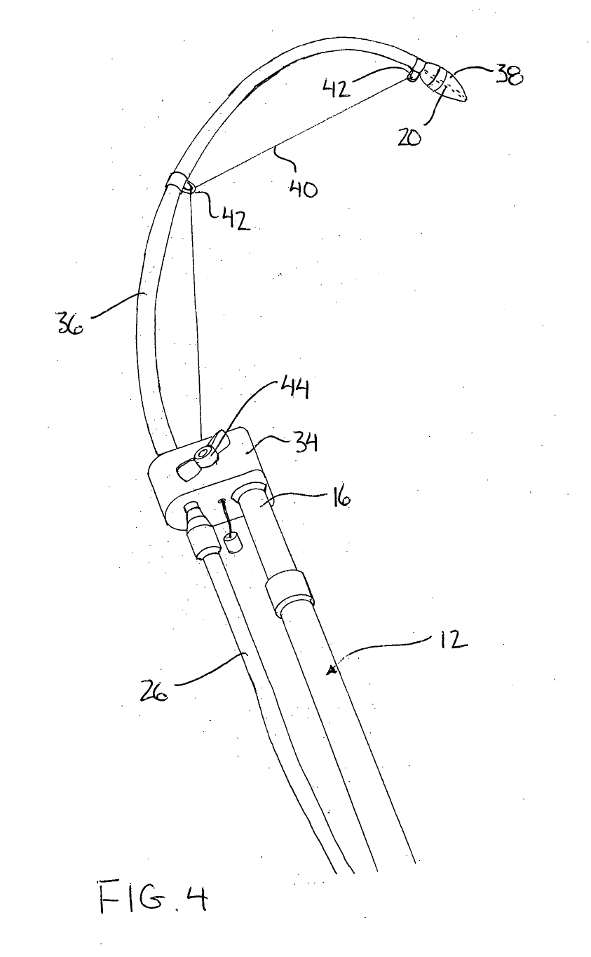

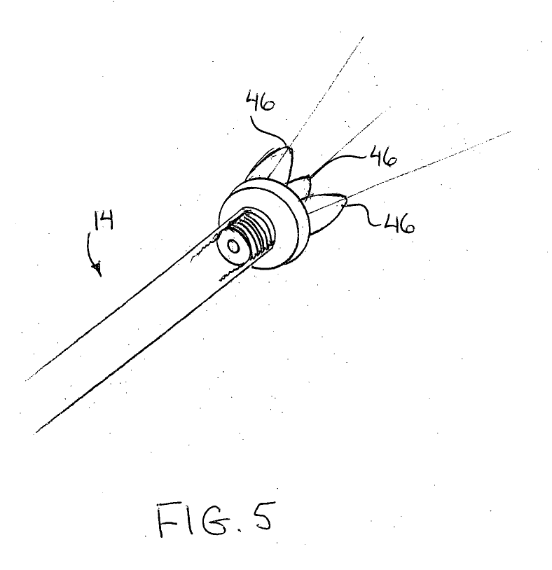

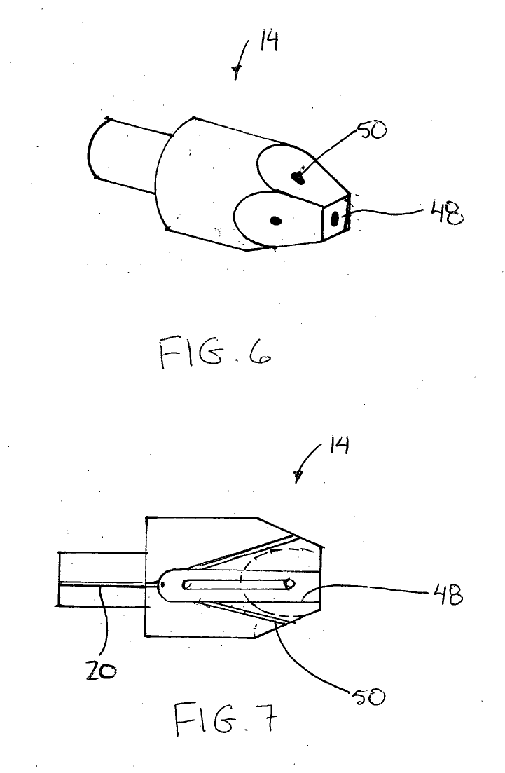

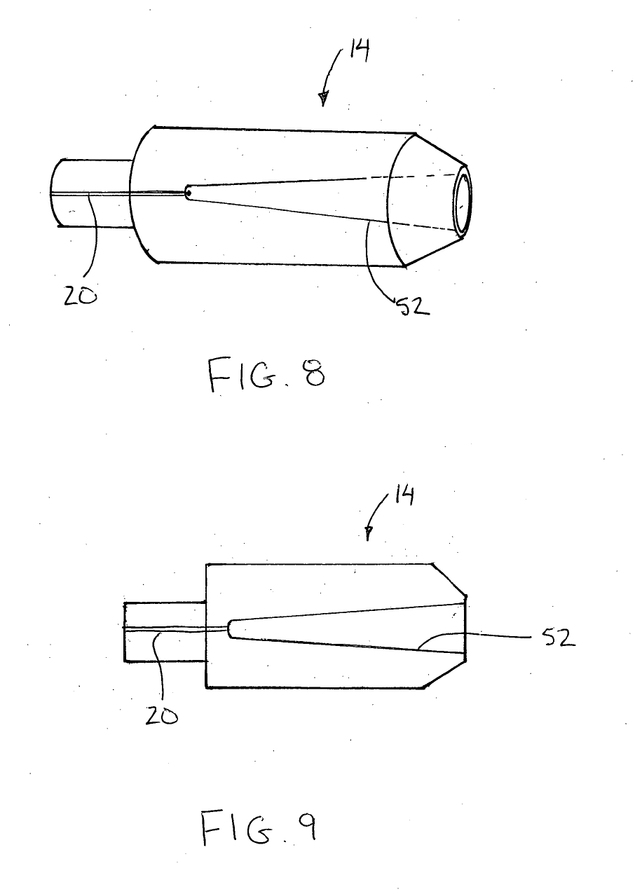

Turning now to the second embodiment of FIGS. 3 and 4, the conduit 26 comprises a hose which extends alongside the pole 12 separate therefrom. The pole in this instance is telescopic by forming the pole in several sections slidably received within one another in which no pressure connections are required at the sliding couplings due to the conduit being separate from the pole. The hose forming the conduit is flexible for accommodating variations in the length of the pole alongside which it is mounted. A high pressure connection 22 is similarly provided in series with the conduit at the bottom end 18 of the pole and a similar shutoff valve 30 is provided for containing pressure within the tank. The tank 24 however may be carried separate from the pole or maybe carried on the pole by a suitable pole connection 32.

A clamp 34 is provided at the top end of the pole for coupling the conduit to the pole parallel thereto and in fixed relationship. The nozzle member 14 in this instance comprises a resilient tube supporting a nozzle tip 38 at the free end thereof. The nozzle tip 38 is directed coaxially with the resilient tube 36 adjacent the free end thereof. The resilient tube 36 is sufficiently stiff to return to a parallel position with the pole in the absence of any other force, however upon pulling the nozzle tip 38 towards the bottom end of the pole, the resilient tube 36 bends in an arc of varying degrees so that the amount which the nozzle is directed back towards the bottom end can be adjusted. A tension member 40 is coupled between the clamp 34 and an eyelet 42 at the nozzle tip 38. Length of the tension member between the clamp 34 and the nozzle tip 38 can be adjusted by sliding the tension member through cooperating apertures in the clamp 34 and then subsequently fixing the tension member relative to the clamp by a suitable screw member 44. One or more additional eyelets 42 may be provided at spaced positions between the clamp and the nozzle tip along the resilient tube 36. The tension member is received through the eyelets 42 so that the tension member is held near the resilient tube 36 of the nozzle member to provide minimal obstruction to the nozzle tip being inserted through the open top end of the gutters to be cleaned.

Turning now to FIG. 5 a further embodiment of the nozzle member 14 is illustrated in which a plurality of nozzle tips 46 are coupled in communication with the passage through the nozzle member. Each of the nozzle tips 46 is directed in a different direction aimed partly in the longitudinal direction of the nozzle member and partly radially outward.

Turning now to FIG. 6 and 7, the nozzle member 14 comprises an enlarged mouth 48 of constant diameter which projects concentrically from the tip of the main narrow passage 20 of the nozzle member. The main mouth 48 is open to the free end of the nozzle member so that a high pressure jet of air through the narrow passage is directed through the open end of the mouth 48. A plurality of auxiliary side passages 50 are coupled to the mouth 48 at circumferentially spaced positions to extend radially outwardly at a forward incline in the direction which the mouth 48 is directed at. The side passages 50 are narrow in dimension similar to the main passage 20 and provide a release for air under pressure if the tip is partially obstructed at the open end of the mouth 48.

Turning now to FIGS. 8 and 9, in a further embodiment of the nozzle member the narrow passage 20 may be connected in series and concentrically with a diverging mouth 52 which increases in diameter from the free end of the main passage 20 to the free end of the nozzle member 14. The diverging mouth 52 has smooth inner walls so that the mouth forms a conical shaped opening through which the main passage 20 is directed.

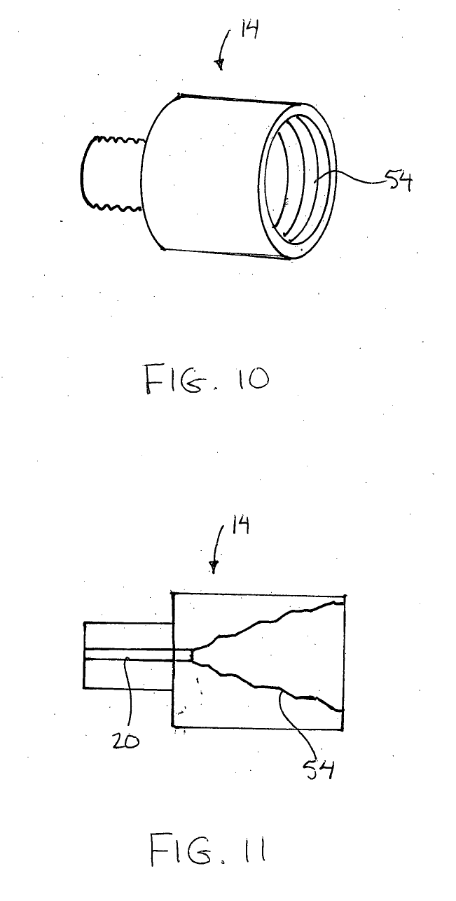

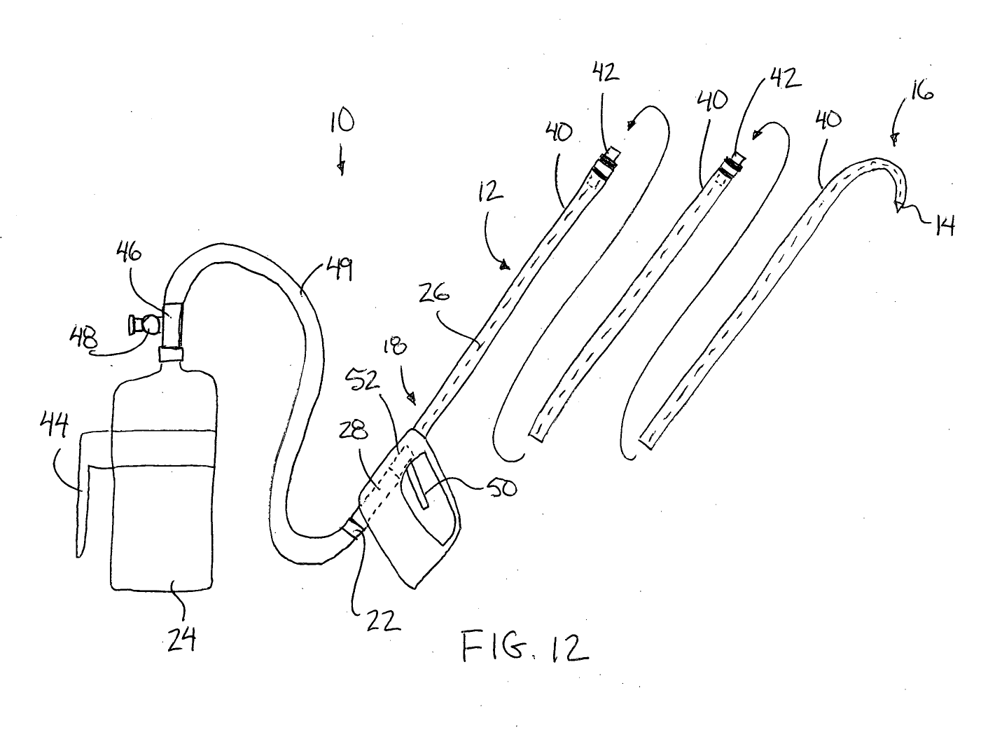

Turning now to FIGS. 10 and 11, a diverging mouth 54 is provided having increasing diameter from the free end of the main passage 20 to the free end of the nozzle member 14 similarly to the previous embodiment, but in which the inner walls of the diverging mouth 54 instead have a stepped internal diameter resulting in a somewhat turbulent effect on the flow of air therethrough.

Turning now to the embodiment of FIG. 12, the pole in this instance comprises an elongate rigid tubular pole formed in modular sections 40 including a base section adjacent the bottom end 18 of the pole and an upper section nearest the top end 16 of the pole. Additional intermediate sections 40 are provided as desired depending upon the required length of the pole between the top and bottom ends. A high pressure connector 42 is provided for connecting each adjacent pair of modular sections 40.

The conduit in this instance comprises a hollow passage extending concentrically through the modular sections of the pole with each high pressure connections 42 comprising a threaded connector with a through passage therein which is sealably connected for high pressure between the adjacent modular sections 40 using resilient O-rings or other similar sealing members to permit the high pressure gas to flow through the connector between the adjacent modular sections while preventing any gas from escaping at the connection.

At the bottom end of the base one of the modular sections 40, the trigger valve mechanism 28 is coupled in series with the conduit. The trigger valve mechanism 28 connects the high pressure connection 22 in series with the conduit.

The tank 24 in this embodiment comprises a small portable tank of suitable size to be carried at the hip of the user. The tank includes a suitable clip 44 secured thereon which is arranged to support the tank clipped onto a waste belt of the person. An outlet connection of the tank includes an inlet T-connector 46. The T-connector 46 connects an inlet for communication through a one way check valve 48 in parallel connection with the tank to the high pressure connection 22 of the device.

A flexible hose 48 connects the inlet T-connector to the high pressure connection in which the flexible hose has a length which is suitable to reach between the tank 24 supported at a hip of the user and an arm's reach of the person supporting the trigger valve mechanism 28 at the bottom of the pole in their hand. The inlet connector is arranged to be connected through the check valve 48 which comprises a one way valve arranged to only permit high pressure gas to flow into the device for refilling the tank when connected to the supply line of a compressor. When the tank is connected to the high pressure connection 22 at the bottom of the pole of the device, the inlet connector is connected to the high pressure connection between the tank and the trigger valve mechanism.

In the embodiment of FIG. 12, the trigger valve mechanism is opened and closed by an actuation lever 50 which is moveable between respective actuated and unactuated positions. The actuation lever is biased towards the unactuated position so that a user must apply force to displace it into the actuated position. Responsive to displacing the lever into the actuated position, the trigger valve mechanism is opened. A metering mechanism 52 couples the actuator lever to the trigger valve mechanism in a manner to disconnect the actuation lever from the trigger valve mechanism once a metered amount of gas has been dispensed to the conduit even if the actuation lever remains in the actuated position. The metering mechanism can comprise an electrical or mechanical timer, a mechanism arranged to meter a specific volume of air being dispensed or any other suitable structure capable of metering a prescribed amount of gas so that even when the actuation lever is held in the actuated position, only a short burst of air is released through the nozzle as the metering mechanism is arranged to return the trigger valve mechanism to the closed position after the metered amount of gas has been dispensed.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A gutter cleaning device using a compressed gas, the device comprising:
an elongate pole extending in a longitudinal direction between a top end and a bottom end;
a nozzle adjacent the top end of the pole which is directed transversely to the longitudinal direction of the pole;
a high pressure connection adjacent the bottom end of the pole which is arranged to connect to a supply of high pressure compressed gas;
a conduit extending in communication between the nozzle adjacent the top end of the pole and the high pressure connection adjacent the bottom end of the pole; and
a trigger valve mechanism connected in series with the conduit and being movable between a closed position restricting release of compressed gas through the conduit from the high pressure connection to the nozzle and an open position in which the high pressure connection openly communicates through the conduit with the nozzle.

2. The device according to claim 1 in combination with a compressed air tank wherein the high pressure connection is connected to the compressed air tank.

3. The device according to claim 1 wherein the high pressure connection is suitably arranged to sealably connect to pressures of up to 2000 psi.

4. The device according to claim 1 wherein there is provided a portable tank storing compressed air therein which is directly coupled to the pole by the high pressure connection.

5. The device according to claim 1 wherein the trigger valve mechanism is located adjacent the bottom end of the pole, spaced from the nozzle by a length of the pole.

6. The device according to claim 1 wherein the nozzle includes a main passage therethrough having a diameter of less than ¼ inch for directing a high pressure jet of air therethrough.

7. The device according to claim 1 wherein the conduit extends concentrically through the pole and wherein the pole comprises a rigid member having a generally U-shaped curve formed adjacent the top end thereof for directing the nozzle at least partially downward toward the bottom end of the pole.

8. The device according to claim 1 wherein the pole comprises a plurality of modular sections connected in series with one another in the longitudinal direction.

9. The device according to claim 8 wherein the conduit extends concentrically through the pole and wherein there is provided a resilient sealing member forming a sealed connection between each adjacent pair of modular sections.

10. The device according to claim 1 wherein there is provided a portable high pressure compressed gas storage tank and a flexible hose coupling the tank in communication with the high pressure connection.

11. The device according to claim 11 wherein there is provided a mounting clip on the tank arranged to support the tank on a belt of a user.

12. The device according to claim 1 wherein there is provided a portable high pressure compressed gas storage tank coupled to the high pressure connection and an inlet connector connected to the high pressure connection between the tank and the trigger valve mechanism and arranged to connect to a compressor, the inlet connector comprising a one way check valve arranged to only permit high pressure gas to flow into the device.

13. The device according to claim 1 wherein there is provided:
an actuation lever biased from an actuated position to an unactuated position and being arranged to displace the trigger valve mechanism into the open when displaced into the actuated position; and
a metering mechanism arranged to return the trigger valve mechanism to the closed position after a metered amount of gas has been dispensed through the trigger valve mechanism in the open position even if the actuation lever remains in the actuated position.

14. The device according to claim 1 wherein orientation of the nozzle is adjustable in relation to the pole.

15. The device according to claim 1 wherein the conduit comprises a separate hose extending alongside the pole.

16. The device according to claim 15 wherein the pole is telescopic.

17. The device according to claim 16 wherein the hose is flexible.

18. The device according to claim 1 wherein there is provided a portable tank storing compressed air therein which is directly coupled to the pole by the high pressure connection, the portable tank being rigidly connected to the pole.

19. A method of cleaning a gutter, the method comprising:
providing cleaning tool comprising: an elongate pole extending between a top end and a bottom end; a nozzle adjacent the top end of the pole which is directed at least partially downward toward the bottom end of the pole; and a conduit extending in communication between the nozzle and the bottom end of the pole;
connecting a supply of compressed gas to the conduit adjacent the bottom end of the pole;
restricting release of compressed gas through the conduit from the supply to the nozzle by providing a trigger valve mechanism connected in series with the conduit; and
periodically releasing the trigger valve mechanism so as to release compressed gas through the conduit, from the supply to the nozzle.

20. The method according to claim 19 including releasing the trigger valve mechanism in short sequential bursts.
